(19) United States
(12) Patent Application Publication
(10) Pub. No.: US 2013/0190436 A1
(43) Pub. Date: Jul. 25, 2013

(54) ADHESIVE GROUT FOR PLASTER REHABILITATION

(71) Applicant: 432339 Ontario Inc., Port Hope (CA)

(72) Inventors: Roderick Milton Stewart, Port Hope, CA (US); Douglas R. Chrisope, LaPlace, LA (US)

(73) Assignee: 432339 Ontario Inc., Port Hope (CA)

(21) Appl. No.: 13/749,375

(22) Filed: Jan. 24, 2013

Related U.S. Application Data
(60) Provisional application No. 61/589,886, filed on Jan. 24, 2012.

(51) Int. Cl. C09J 133/04

(52) U.S. Cl. CPC C09J 133/04
USPC 524/261; 524/428

(57) ABSTRACT

An adhesive grout for plaster rehabilitation. The grout formulation includes fluid petroleum coke, an acrylic resin, a pseudo-plastic thickener formed from an anionic thickener with ammonium hydroxide in a water solution to form a salt thereof, inert filler microspheres of an intermediate particle size, and inert filler particles of a small particle size, wherein the inert filler particles comprise diatomaceous earth, pyrogenic silica, or methylated silica. The grout excludes calcium hydroxide.

### CROSS-REFERENCE TO RELATED APPLICATIONS

The present application claims priority to U.S. provisional patent application Ser. No. 61/589,886, filed Jan. 24, 2012, and owned in common herewith, the contents of which are hereby incorporated herein by reference in its entirety.

### FIELD

The present application generally relates to restoration work in connection with plaster ceilings and, in particular, to a non-shrink adhesive grout for plaster rehabilitation and conservation.

### BACKGROUND

Many historic and architecturally significant buildings have plaster ceilings, walls, and ornamental features. In many of these buildings, over time, the plaster becomes structurally compromised as the mechanical keys that physically hold the plaster onto the lath break. In some cases, the plaster begins to pull away from the lath and starts to sag or fall.

Conservation and restoration work aims to preserve plaster ceilings that are in danger of sagging or falling. Historically, one technique for reattaching plaster has been to apply a layer of reinforcing plaster along the reverse side of the lath (where accessible) so as to bond to the remaining keys and the stubs of the broken keys. However, this added weight may be a concern in some cases and the bond line between the old plaster and the new plaster can be a common weak point.

Another technique that has found favour is the injection of a formulation of acrylic-resin-based adhesive into the space between the plaster and the lath. The adhesive may be injected through holes drilled into the front of the plaster, although that requires that the plaster be defaced when small injection holes are drilled in its visible front surface. This in unsuitable for plaster decorated with paintings or wall coverings. Another technique, if the back of the lath is accessible, is to inject into the gaps between the laths and/or drill holes in the laths and inject the adhesive into the holes. The adhesive fills the gaps between the upper surface of the plaster and the laths and makes a new bonded connection at each location where the adhesive has been injected. The non-shrink characteristic is significant since, once the adhesive has been placed and has bonded, any later shrinkage will cause considerable stress on the plaster and may result in hairline cracks. The technique and formulation was described by Morgan Phillips in “Adhesives for the Reattachment of Loose Plaster”, Bulletin of the Association for Preservation Technology, Vol. XII, No. 2, 1980, pp. 37-63 (hereinafter “Phillips”). The contents of this paper are hereby incorporated by reference.

One of the drawbacks of the formulation proposed by Phillips is that it must be mixed immediately prior to use and if stored for more than about 4 to 6 hours, the material ‘flattens out’ and loses its non-shrink characteristics. Longer storage results in the material losing its pseudo-plastic characteristic.

Once mixed the material must be loaded into a bulk loading caulking gun for immediate application, which must then be cleaned thoroughly after each use.

Mixing of the material occurs on-site and is a gritty messy task. The hand mixing of the material results in the possibility of lumps of unmixed material clogging the nozzle of the caulking gun. Moreover, hand-mixing of the material can be inaccurate.

### DESCRIPTION OF EXAMPLE EMBODIMENTS

In one aspect, the present application describes an adhesive grout for plaster rehabilitation. The grout includes fluid petroleum coke; an acrylic resin; a pseudo-plastic thickener formed from an anionic thickener with ammonium hydroxide in a water solution to form a salt thereof; inert filler microspheres of an intermediate particle size; and inert filler particles of a small particle size, wherein the inert filler particles comprise diatomaceous earth, pyrogenic silica, or methylated silica.

In another aspect, the adhesive grout excludes calcium hydroxide.

Other aspects and features of the present application will be understood by those of ordinary skill in the art from a review of the following description of examples in conjunction with the accompanying figures.

Any references herein to “lime” are intended to mean “hydrated lime”, i.e. calcium hydroxide, and not calcium oxide. Calcium oxide is sometimes referred to as quicklime or burnt lime. The term “lime”, as used in this application, specifically means calcium hydroxide.

The adhesive grout described by Phillips includes lime or chalk, with lime being preferable. A specific formulation Phillips proposes (by volume) is:

2 parts lime

2 parts microballoons

2 parts fluid coke

3 parts of a mixture of 3 Rhoplex™ MC-76 to 1 Rhoplex™ LC-67

¼ part water

Thickener as desired

The thickener solution may be an ammonium salt solution of Acrysol™ ASE-60, although other anionic thickeners may be used. A thickener may be selected on the basis that it exhibits “thixotropic” or “pseudo-plastic” properties.

Phillips' reference to lime is more properly understood as “hydrated lime”, or calcium hydroxide, i.e. Ca(OH)₂. Calcium hydroxide, as an alkali earth metal hydroxide, is fairly reactive although not very soluble in water. Phillips suggests the use of hydrated lime as a fine particle-size filler. Chalk, i.e. calcium carbonate, CaCO₃, is suggested as a possible alternative, although Phillips states that lime is preferred due to its likely contribution to the easy working properties of the adhesive.

It has been determined that the calcium hydroxide reacts with the thickener and tends to “flatten it out” over time. If the lime and thickener are combined, then the product loses its pseudo-plastic characteristic within about 24 hours. Accordingly, the product cannot be prepared and stored. This makes the formulation unsuitable for pre-mixing and packaging. As a result, it is necessary to mix the formulation on site, which is messy, time-consuming and sometime results in a poorly mixed adhesive.

Another problem with pre-mixing the formulation is that the fluid coke reacts with water or other liquids to produce gasses that give the mixture its non-shrink characteristics. Small bubbles of released gas become trapped in the thickened mixture and have an expansive effect, which compensates for the loss of volume due to the drying of the adhesive, i.e. the loss of water. The adhesive begins to lose its non-shrink characteristic 4-6 hours after mixing. Accordingly, the fluid coke is mixed with the other components on-site just prior to use. Phillips suggests the use of an electric drill or kitchen mixer. He also notes the hazardous nature of some of the materials, the need to wear protective equipment, and the possible difficulty in cleaning the equipment after use.

In accordance with one aspect of the present application, a formulation is provided for the adhesive that can be pre-packaged and stored prior to use. A container is described for pre-packaging the materials and methods of mixing and applying the adhesive are detailed. The container may, in some implementations, be an adhesive tube of the size and shape typically used for application of adhesives using a caulking gun. The adhesive tube may be structured to have two internal cavities separated by a temporary membrane or other breakable barrier. An example of such a tube is described in U.S. provisional patent application Ser. No. 61/442,434, filed Feb. 14, 2011, and owned in common herewith, the contents of which are hereby incorporated by reference.

In a first embodiment, the formulation includes fluid coke and calcium hydroxide (lime), as described by Phillips, but the fluid coke and lime are premixed and packaged in one of the cavities within the adhesive tube. The remaining ingredients are pre-mixed and packaged in the other of the cavities within the adhesive tube. In this manner, both the fluid coke and the lime are kept separate from the other pre-mixed ingredients during storage and prior to use.

To use the adhesive, the temporary membrane is pierced and the contents of the two cavities are mixed inside of the adhesive tube. The mixing may take place by way of a long drill bit or bit extension with an expandable flange. In one case, the expandable flange may be provided by conventional toggle bolt wings.

The need to mix both fluid coke and lime into the other materials may require a lengthy mixing time, and it is possible that lumps may form that are not fully broken up by the mixing if it is not performed thoroughly.

Accordingly, in a second embodiment the adhesive excludes hydrated lime. In its place, a different inert small particle thickener is used. In one embodiment, the inert small particle thickener used is chalk (calcium carbonate). In another embodiment, the inert small particle thickener is diatomaceous earth. In a further embodiment, the inert small particle thickener is pyrogenic silica, a manufactured non-crystalline form of silicon dioxide. In yet another embodiment, the inert small particle thickener is methylated silica. In any of these cases, the inert small particle thickener is pre-mixed with the other ingredients excluding the fluid coke. The fluid coke is placed in its own cavity and the pre-mixed other ingredients are placed in a separate cavity in the adhesive tube. Thus, only the fluid coke needs to be mixed with the remaining ingredients when the interior membrane is pierced.

By using an inert small particle thickener, other than lime, the problem with the material “flattening out” over time due to the lime losing its pseudo-plastic characteristic is avoided. The thickener remains stable for a longer period of time both in storage and after mixing whilst the adhesive is curing.

One example formulation for the adhesive grout is (by volume):

2 parts diatomaceous earth

2 parts microballoons

2 parts fluid coke

3 parts of an acrylic resin (for example, a mixture of 3 Rhoplex™ MC-76 to 1 Rhoplex™ LC-67)

¼ part water

Thickener as desired

Another example formulation for the adhesive grout is (by volume):

2 parts methylated silica

2 parts microballoons

2 parts fluid coke

3 parts of an acrylic resin (for example, a mixture of 3 Rhoplex™ MC-76 to 1 Rhoplex™ LC-67)

¼ part water

Thickener as desired

The thickener may, in some embodiments, be a pseudo-plastic thickener formed from an anionic thickener with ammonium hydroxide in a water solution to form a salt thereof For example, the thickener solution may be an ammonium salt solution of Acrysol™ ASE-60, although other anionic thickeners may be used. A thickener may be selected on the basis that it exhibits “thixotropic” or “pseudo-plastic” properties.

The proportions set out in the example formulations above are approximate and may be varied for particular applications. In general, suitable ranges (by weight) for the various ingredients are as follows:

| | | |
|---|---|---|
| Fine, inert particles | 5-25% | (more dense materials will have a |
| | | higher percentage by weight) |
| Microballons | 2-6% | |
| Fluid coke | 20-30% | |
| Acrylic resin | 40-60% | |
| Water | 3-8% | |
| Thickener | 0-15% | |

Certain adaptations and modifications of the described embodiments can be made. Therefore, the above discussed embodiments are considered to be illustrative and not restrictive.

What is claimed is:

1. An adhesive grout for plaster rehabilitation, comprising:
fluid petroleum coke;
an acrylic resin;
a pseudo-plastic thickener formed from an anionic thickener with ammonium hydroxide in a water solution to form a salt thereof;
inert filler microspheres of an intermediate particle size; and
inert filler particles of a small particle size, wherein the inert filler particles comprise diatomaceous earth, pyrogenic silica, or methylated silica.

2. The adhesive grout of claim 1, wherein the grout excludes calcium hydroxide.

3. The adhesive grout of claim 1, wherein the inter filler particles consist of diatomaceous earth.

4. The adhesive grout of claim 1, wherein the inter filler particles consist of pyrogenic silica.

5. The adhesive grout of claim 1, wherein the inter filler particles consist of methylated silica.

6. The adhesive grout of claim 1, wherein the inert filler particles comprise between about 5-25% of the grout by weight.

7. The adhesive grout of claim 6, wherein the fluid petroleum coke comprises between about 20-30% by weight, and the acrylic resin comprises between about 40-60% by weight.

8. The adhesive grout of claim 7, wherein the microspheres comprise between about 2-6% by weight, the pseudo-plastic thickener comprises between about 0-15% by weight, and wherein the grout further comprises water in an amount of between about 3-8% by weight.

9. The adhesive grout of claim 1, wherein the grout comprises, by volume, about 2 parts inert filter particles of the small particle size, about 2 parts fluid petroleum coke, about 2 parts microspheres, and about 3 parts acrylic resin.

10. The adhesive grout of claim 9, wherein the grout further comprises, by volume, about ¼ part water.

11. The adhesive grout of claim 1, wherein the anionic thickener comprises Acrysol™ ASE-60.

12. The adhesive grout of claim 1, wherein the fluid petroleum coke is packaged separately from the other ingredients, and the other ingredients are pre-mixed prior to packaging.

13. The adhesive grout of claim 1, wherein the fluid petroleum coke and the inert filler particles of a small particle size are premixed and packaged separately from the other ingredients.
